(19) United States
(12) Patent Application Publication
(10) Pub. No.: US 2004/0207591 A1
(43) Pub. Date: Oct. 21, 2004

(54) Method and circuit for driving liquid crystal display

(75) Inventor: Ching-Tung Wang, Hsinchu (TW)

Correspondence Address: QUINTERO LAW OFFICE, 1617 BROADWAY, 3RD FLOOR, SANTA MONICA, CA, 90404, US

(73) Assignee: Toppoly Optoelectronics Corp.

(21) Appl. No.: 10/419,630

(22) Filed: Apr. 21, 2003

(51) Int. Cl. G09G 3/36

(52) U.S. Cl. 345/96

(57) ABSTRACT

A driving method of an LCD panel having a driving IC and a plurality of display groups comprising a plurality of display cells and are respectively coupled to a data electrode and a gate electrode. The driving IC simultaneously drives one display cell in each display group on the same row. First, video signals are provided by the driving IC to one display cell in each display group on the same row. Here, the display cells of adjacent display groups receive opposite polarity video signals. Finally, the scan signals are provided to the gate electrodes.

### BACKGROUND OF THE INVENTION

1. Field of the Invention

The present invention relates in general to a method and a circuit for driving a liquid crystal display (LCD). In particular, the present invention relates to a method for driving an LCD having display cells driven by a driving IC to eliminate crosstalk and improve image quality.

2. Description of the Related Art

FIG. 1 is a schematic diagram of a conventional liquid crystal display panel (hereinafter, referred to as an “LCD panel”) and the peripheral driving circuits thereof. As shown in the figure, an LCD panel 1 is formed by interlacing data electrodes (represented by D1, D2, D3, . . . , Dm) and gate electrodes (represented by G1, G2, G3, . . . , Gm), each of the interlaced data electrodes and gate electrodes control a display cell. As an example, interlacing data electrode D1 and gate electrode G1 control the display cell 200. The equivalent circuit of each display cell comprises thin film transistors (TFTs) (Q11-Q1m, Q21-Q2m, . . . , Qn1-Qnm) and storage capacitors (C11-C1m, C21-C2m, . . . , Cn1-Cnm). The gates and drains of these TFTs are respectively connected to gate electrodes (G1-Gn) and data electrodes (D1-Dm). Such a connection can turn on/off all TFTs on the same line (i.e. positioned on the same scan line) using a scan signal of gate electrodes (G1-Gn), thereby controlling the video signals of the data electrodes to be written into the corresponding display cell. It is noted that a display cell only controls the brightness of a single pixel on the LCD panel.

Accordingly, each display cell responds to a single pixel on a monochromatic LCD while each display cell responds to a single subpixel on a color LCD. The subpixel can be red (represented by “R”), blue (represented by “B”), or green (represented by “G”). In other words, a single pixel is formed by an RGB (three display cells) combination.

In addition, FIG. 1 also shows a part of the driving circuit of the LCD panel 1. The gate driver 10 outputs one or more scan signals (also referred to as scan pulses) of each of the gate electrodes G1, G2, . . . , Gn according to a predetermined sequence. When a scan signal is carried on one gate electrode, the TFTs within all display cells on the same row or scan line are turned on while the TFTs within all display cells on other rows or scan lines may be turned off. When a scan line is selected, data driver 20 outputs a video signal (gray value) to the m display cells of the respective rows through data electrodes D1, D2, . . . , Dm according to the image data to be displayed. After gate driver 10 scans n rows continuously, the display of a single frame is completed. Thus, repeated scans of each scan line can achieve the purpose of continuously displaying an image. As shown in FIG. 1, signal CPV indicates the clock of the gate driver 10, signal CTR indicates the scan control signal received by the gate driver 10, signal LD indicates a data latch signal of the data driver 20, and signal DATA indicates the image signal received by the data driver 20.

Typically, a video signal, which is transferred by the data electrodes D1, D2, . . . , Dm, is divided into a positive video signal and a negative video signal based on the relationship with the common electrode voltage VCOM. The positive video signal indicates a signal having a voltage level higher than the voltage VCOM, and based on the gray value represented, the actual produced potential of the signal ranges between voltages Vp1 and Vp2. In general, a gray value is lower if it is closer to the common electrode voltage VCOM. On the other hand, the negative video signal indicates that the signal has a voltage level lower than the voltage VCOM, and based on the gray value represented, the actual produced potential of the signal ranges between voltages Vn1 and Vn2. Also, the gray value is lower if it is closer to the common electrode voltage VCOM. When a gray value is represented, whether in a positive or negative video signal, the display effect is substantially the same.

In order to prevent the liquid crystal molecule from continuously receiving a single-polar bias voltage, thus reducing the life span of liquid crystal molecules, a display cell alternately receives positive and negative polar video signals corresponding to odd and even frames.

The disposition of the different polar video signal in each display cell can be divided into four driving types: frame inversion, line inversion, column inversion, and dot inversion. In the frame inversion driving mode, the polarity of the video signal is the same on the same frame but opposite to its adjacent frames. In the line or column inversion driving mode, the same line or column on the same frame has the same polarity of the video signal but the opposite polarity to its adjacent lines or columns. In the dot inversion driving mode, the polarity of the video signal on the same frame is presented in an interlaced form, which is the type described in the present invention.

FIG. 2 shows the polarity of the video signals received by each display cell on the LCD panel 3 in dot inversion driving mode. In FIG. 2, the LCD panel 3 comprises a plurality of display cells. The display cells responding to the same gate electrode are connected to different data electrodes, respectively. In dot inversion driving mode, the polarity of each display cell is opposite to its adjacent display cells connected to the same gate electrode or data electrode in a frame.

As mentioned above, when a gray value is represented, whether in a positive or negative video signal, the display effect is substantially the same. In addition, the number of the positive video signals and negative video signals received by a data electrode is the same. Thus, the common electrode voltage VCOM is not obviously shifted.

FIG. 3 shows the display cells of the LCD panel driven by the corresponding channels of the conventional driving IC at the same time. As shown in FIG. 3, the driving ICs 30A and 30B comprise 256 output channels E1˜E256 and F1˜F256, respectively. The channels are connected to the display cell through the data electrode. The display cells are labeled as 321A˜321C, 322A˜322C, 323A˜323C. The detailed structure of the display cells is shown in FIG. 1.

The conventional driving method of the display cells by the driving IC is described. The output channels E1˜E256 of the driving IC 30A output positive polarity video signals to one display cell in each display group, and then output negative polarity video signals to another display cell in each display group. For example, the driving IC 30A outputs positive polarity video signals to the display cells 321A, 322A and 323A of the display groups 31A˜31C, and then outputs negative polarity video signals to the display cells 321B, 322B and 323B of the display groups 31A˜31C. In addition, the operation of the driving IC 30B is similar to that of driving IC 30A. The structure disclosed in FIG. 3 improves the efficiency of providing video signals to the display cells.

However, when the driving IC drives the display cells by the conventional method, each display cell receives the same polarity video signal. Thus, the common electrode voltage VCOM is shifted by electric coupling and causes an error in the gray level of the display cell. For example, the common electrode voltage VCOM is raised when the driving IC 30A outputs positive polarity video signals to the display cells 321A, 322A, and 323A of the display groups 31A˜31C. On the contrary, the common electrode voltage VCOM is lowered when the driving IC 30A outputs negative polarity video signals to the display cells 321B, 322B, and 323B of the display groups 31A˜31C. Since the common electrode voltage VCOM is variable, the gray level of each display cell is inaccurate and the display effect of the LCD panel deteriorates.

### SUMMARY OF THE INVENTION

The object of the present invention is thus to provide a method and a circuit for driving an LCD using a driving IC to simultaneously provide video signals to the data electrodes at on the same row to prevent the common electrode voltage VCOM from shifting due to electrical coupling.

To achieve the above-mentioned object, the present invention provides a driving method of an LCD panel having a driving IC and a plurality of display groups comprising a plurality of display cells and respectively coupled to a data electrode and a gate electrode. One display cell in each of the display groups on the same row are simultaneously driven by the driving IC. First, video signals are provided by the driving IC to one display cell in each display group on the same row. Here, the display cells of adjacent display groups receive video signals of opposite polarity. Finally, the scan signals are provided to the gate electrodes.

In addition, the present invention provides a driving circuit of an LCD panel having a plurality of display groups respectively coupled to a data electrode and a gate electrode and comprising a plurality of display cells. The gate driver provides the scan signals to the gate electrodes. The driving IC simultaneously drives one display cell in each display group on the same row through the data electrode and then drives the other display cells of the display groups.

In addition, the present invention provides an LCD panel. The display groups comprise a plurality of display cells, respectively. The gate electrodes are coupled to the corresponding display cells. The data electrodes are coupled to the display cells corresponding to the gate electrodes. The driving IC provides a plurality of video signals to simultaneously drive one display cell in each display group on the same row through the data electrode. The display cells of the adjacent display groups receive opposite polarity video signals.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a schematic diagram of a conventional LCD panel and the peripheral driving circuits thereof.

FIG. 2 shows the polarity of the video signals received by each display cell on the LCD panel 3 in dot inversion driving mode.

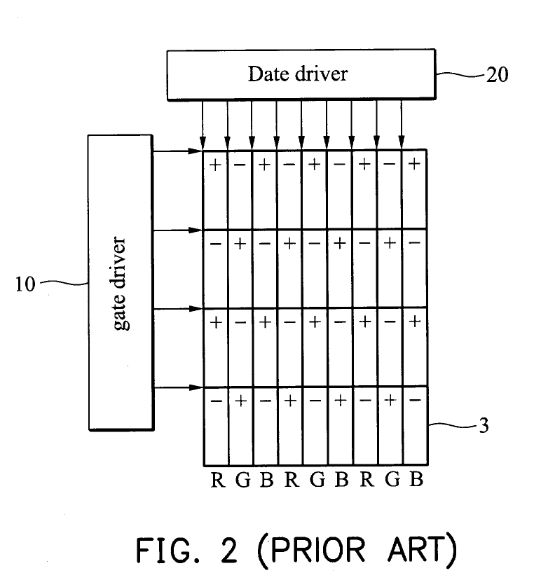

FIG. 3 shows the display cells of the LCD panel driven by the corresponding channels of the conventional driving IC at the same time.

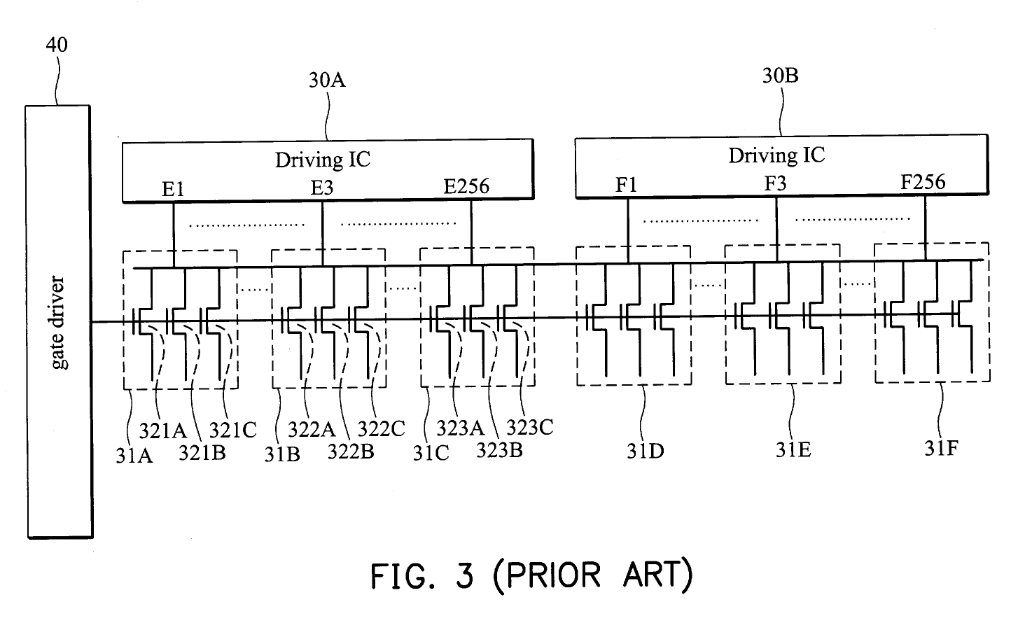

FIG. 4 is a schematic diagram of the LCD panel and the peripheral driving circuits thereof according to the embodiment of the present invention.

### DETAILED DESCRIPTION OF THE INVENTION

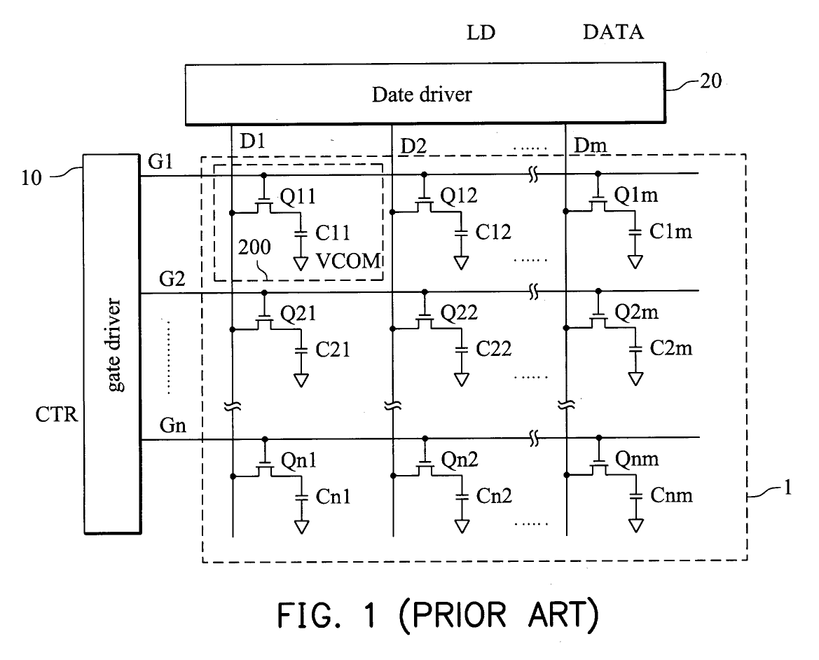

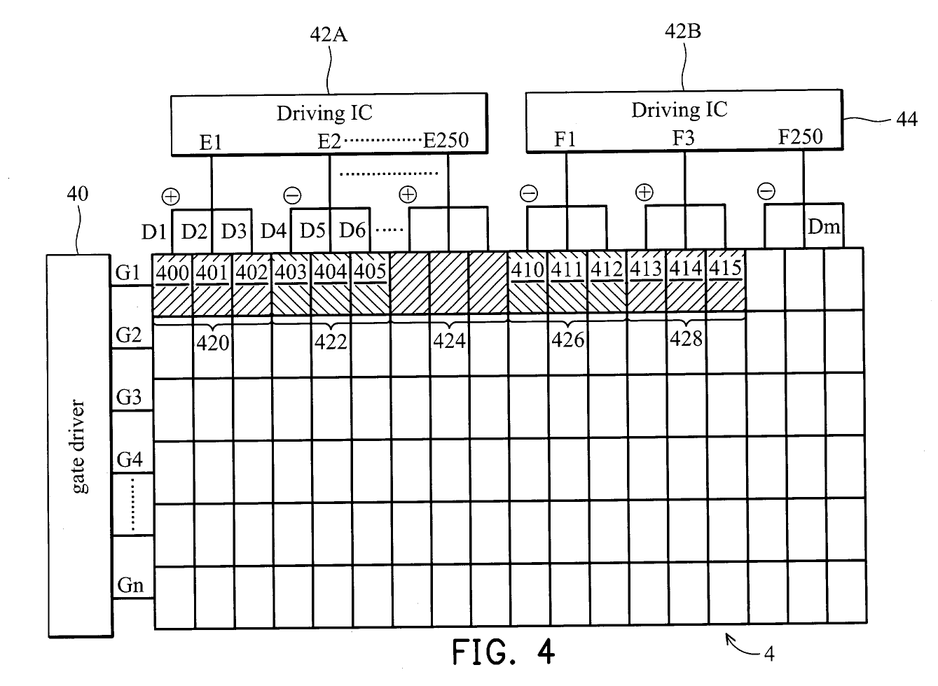

FIG. 4 is a schematic diagram of the LCD panel and the peripheral driving circuits thereof according to the embodiment of the present invention. As shown in the figure, an LCD panel 4 is formed by interlacing data electrodes (represented by D1, D2, D3, . . . , Dm) and gate electrodes (represented by G1, G2, G3, . . . , Gm), each of the interlacing data electrodes and gate electrodes control a display group. For example, interlacing data electrode D1 and gate electrode G1 control the display cell 400 and interlacing data electrode D2 and gate electrode G1 control the display cell 401. Here, the display cells 400˜402 comprise the display group 420, the display cells 403˜405 comprise the display group 422, the display cells 410˜412 comprise the display group 426 and the display cells 413˜415 comprise the display group 428. The detailed circuit of each display cell is referred to as the display cell 200 shown in FIG. 1. The equivalent circuit of each display cell comprises thin film transistors (TFTs) (Q11-Q1m, Q21-Q2m, . . . , Qn1-Qnm) and storage capacitors (C11-C1m, C21-C2m, . . . , Cn1-Cnm). The gates and drains of these TFTs are respectively connected to gate electrodes (G1-Gn) and data electrodes (D1-Dm). Such a connection can turn on/off all TFTs on the same line (i.e. positioned on the same scan line) using a scan signal of gate electrodes (G1-Gn), thereby controlling the video signals of the data electrodes to be written into the corresponding display cell.

The gate driver 40 outputs one or more scan signals (also referred to as scan pulses) of each of the gate electrodes G1, G2, . . . , Gn according to a predetermined sequence. When a scan signal is carried on one gate electrode, the TFTs within all display cells on the same row or scan line are turned on while the TFTs within all display cells on other rows or scan lines may be turned off. When a scan line is selected, the output channels E1˜E256 of the driver IC 42A output video signals (gray value) to one display cells in each display group on the same row. Here, the polarities of the video signals output by the adjacent channels are opposite. For example, channel E1 of the driving IC 42A outputs positive polarity video signal to the display cell 400 through the data electrode D1. At the same time, channel E2 of the driving IC 42A outputs negative polarity video signal to the display cell 403 through the data electrode D4. In addition, channel F1 of the driving IC 42B outputs negative polarity video signal to the display cell 410 through the corresponding data electrode. At the same time, channel F2 of the driving IC 42B outputs positive polarity video signal to the display cell 413. Furthermore, the polarity of video signals output by the other output channels follow rule mentioned above. After the gate driver 40 scans n rows continuously, the display of a single frame is completed. Thus, repeated scans of each scan line can achieve the purpose of continuously displaying an image.

According to the present invention, the polarities of the video signals output by the driving IC are different at the same time. Thus, the shift of the common electrode voltage VCOM when a conventional driving IC outputs video signals of the same polarity is prevented. It is because the display cells on the same row are of the same polarity when the LCD uses a driving IC to simultaneously drive a plurality of display cells, thus counteracting the influence of the common electrode voltage VCOM and preventing the common electrode voltage VCOM shift by coupling and resulting crosstalk.

Accordingly, the method and the circuit of the present invention for driving the LCD mentioned above prevent the common electrode voltage VCOM shift by electric coupling, and resulting crosstalk between display cells.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A driving method of an LCD panel having a driving IC and a plurality of display groups comprising a plurality of display cells and respectively coupled to a data electrode and a gate electrode, one display cell in each display group on the same row simultaneously driven by the driving IC, comprising the following steps:
providing video signals from the driving IC to one display cell in each display group on the same row, wherein the display cells of the adjacent display groups receive opposite polarity video signals; and
providing scan signal to the gate electrode.

2. The driving method as claimed in claim 1, wherein the adjacent display cells in each display group receive opposite polarity video signals.

3. A driving circuit of an LCD panel having a plurality of display groups respectively coupled to a data electrode and a gate electrode and comprising a plurality of display cells, comprising:
a gate driver for providing scan signals to the gate electrodes; and
a driving IC for simultaneously driving one display cell in each display group with opposite polarity video signals on the same row through the data electrode and then driving the other display cells of the display groups.

4. The driving circuit as claimed in claim 3, wherein the adjacent display cells in each display group receive opposite polarity video signals.

5. The driving circuit as claimed in claim 3, wherein the driving IC further comprises a plurality of channels respectively connected to the display groups through the corresponding data electrodes and for driving one display cells in each display group simultaneously.

6. The driving circuit as claimed in claim 5, wherein the driving IC comprises 256 channels.

7. AN LCD panel, comprising;
a plurality of display groups comprising a plurality of display cells, respectively;
a plurality of gate electrodes coupled to the corresponding display cells;
a plurality of data electrodes coupled to the display cells corresponding to the gate electrodes; and
a driving IC for providing a plurality of video signals to simultaneously drive one display cell in each display group on the same row through the data electrode, wherein the display cells of the adjacent display groups receive opposite polarity video signals.

8. The LCD panel as claimed in claim 7, wherein the adjacent display cells in each display group receive opposite polarity video signals.

9. The LCD panel as claimed in claim 7, wherein the driving IC further comprises a plurality of channels respectively connected to the display groups through the corresponding data electrodes for simultaneously driving one display cell in each display group.

10. The LCD panel as claimed in claim 7, wherein the driving IC comprises 256 channels.
